(19) United States
(12) Patent Application Publication
(10) Pub. No.: US 2025/0378376 A1
(43) Pub. Date: Dec. 11, 2025

(54) METROLOGY USING REFERENCE-BASED SYNTHETIC SPECTRA

(71) Applicant: KLA Corporation, Milpitas, CA (US)

(72) Inventor: Houssam Chouaib, San Jose, CA (US)

(21) Appl. No.: 18/968,732

(22) Filed: Dec. 4, 2024

Related U.S. Application Data
(60) Provisional application No. 63/656,107, filed on Jun. 5, 2024.

(51) Int. Cl. G06N 20/00; G01B 21/00

(52) U.S. Cl. CPC G06N 20/00; G01B 21/00

(57) ABSTRACT

A metrology system may implement a metrology recipe by generating a real training dataset for a metrology measurement, generating a synthetic training dataset for the metrology measurement, training a machine learning model to generate a value of the metrology measurement with the real training dataset and the synthetic training dataset, and generating metrology measurements for one or more run-time samples from measurement data associated with the one or more run-time samples. The real training dataset may be generated by receiving reference data, performing a dimensionality reduction operation, and identifying one or more correlated principal components of the real training data that satisfy a first correlation threshold with the reference data. The synthetic training dataset may then be generated by extracting the same correlated principal components from synthetic training data and filtering to satisfy a correlation threshold with the reference data as well.

### CROSS-REFERENCE TO RELATED APPLICATION

The present application claims the benefit under 35 U.S.C. § 119 (e) of U.S. Provisional Application Ser. No. 63/656,107, filed Jun. 5, 2024, entitled REFERENCE BASED SYNTHETIC SPECTRA DOE, naming Houssam Chouaib as inventor, which is incorporated herein by reference in the entirety.

### TECHNICAL FIELD

The present disclosure relates generally to spectral ellipsometry metrology incorporating machine learning models and, more particularly, to generating synthetic training data for machine learning models used in spectral ellipsometry metrology.

### BACKGROUND

Many current optical metrology applications for integrated circuit manufacturing require complex spectroscopic analysis. Further, the number of critical process steps requiring sensitive metrology is continuing to increase while the window of tolerance and the precision limits of metrology techniques are tightening significantly.

Some current optical metrology techniques rely on conventional rigorous-coupled-wave-analysis (RCWA), which has the disadvantages of a relatively long time to solution and often lacks the required robustness to adapt to process variations. RCWA based solutions further require extensive computational resources and repeating arrays.

Some current optical metrology techniques utilize machine learning models to generate metrology measurements based on measured data. However, machine learning models typically require substantial amounts of training data to provide a desired measurement accuracy. Real training data generated based on measurements of fabricated samples with varying parameters typically has high quality, but is time consuming to generate. Efforts to supplement real training data with model-based supplemental training data have provided only limited success and is in some cases counterproductive.

There is therefore a need to develop systems and methods to address the above deficiencies.

### SUMMARY

In embodiments, the techniques described herein relate to a metrology system, including a controller including one or more processors configured to execute program instructions causing the one or more processors to implement a metrology recipe by generating a real training dataset for a metrology measurement by receiving real training data from test features on one or more training samples from a first metrology sub-system; receiving reference data associated with the metrology measurement for the test features from a second metrology sub-system; performing a dimensionality reduction operation on the real training data; identifying one or more correlated principal components of the real training data that satisfy a first correlation threshold with the reference data; and generating the real training dataset by filtering the real training data to include portions of the real training data associated with the one or more correlated principal components; generating a synthetic training dataset for the metrology measurement by generating synthetic training data for a plurality of simulated test features having known simulated values of the metrology measurement; extract the one or more correlated principal components from the synthetic training data as dimensionality-reduced synthetic training data; and generating the synthetic training dataset by filtering the dimensionality-reduced synthetic training data to include portions of the dimensionality-reduced synthetic training data that satisfy a second correlation threshold with the reference data; training a machine learning model to generate a value of the metrology measurement with the real training dataset and the synthetic training dataset; and generating metrology measurements for one or more run-time samples from measurement data associated with the one or more run-time samples.

In embodiments, the techniques described herein relate to a metrology system, where the dimensionality reduction operation includes a principal component analysis.

In embodiments, the techniques described herein relate to a metrology system, where the metrology measurement includes at least one of an overlay measurement or a critical dimension measurement.

In embodiments, the techniques described herein relate to a metrology system, where the first metrology sub-system includes an optical metrology tool.

In embodiments, the techniques described herein relate to a metrology system, where the first metrology sub-system includes at least one of a spectral ellipsometry tool or a spectral reflectometry tool.

In embodiments, the techniques described herein relate to a metrology system, where the second metrology sub-system includes at least one of a particle-beam metrology tool or an x-ray metrology tool.

In embodiments, the techniques described herein relate to a metrology system, where the second metrology sub-system includes at least one of a transmission electron microscope, a transmission small-angle x-ray scattering tool, a scanning electron microscope, a critical dimension scanning electron microscope, or an atomic force microscope.

In embodiments, the techniques described herein relate to a metrology system, where at least one of the first correlation threshold or the second correlation threshold is a goodness-of-fit threshold.

In embodiments, the techniques described herein relate to a metrology system, where at least one of the first correlation threshold or the second correlation threshold is an R² threshold.

In embodiments, the techniques described herein relate to a metrology system, where the first correlation threshold is equal to the second correlation threshold.

In embodiments, the techniques described herein relate to a metrology system, where the second correlation threshold is greater to the second correlation threshold.

In embodiments, the techniques described herein relate to a metrology system, including a first metrology sub-system; a second metrology sub-system; and a controller including one or more processors configured to execute program instructions causing the one or more processors to implement a metrology recipe by generating a real training dataset for a metrology measurement by receiving real training data from test features on one or more training samples from the first metrology sub-system; receiving reference data associated with the metrology measurement for the test features from the second metrology sub-system; performing a dimensionality reduction operation on the real training data; identifying one or more correlated principal components of the real training data that satisfy a first correlation threshold with the reference data; and generating the real training dataset by filtering the real training data to include portions of the real training data associated with the one or more correlated principal components; generating a synthetic training dataset for the metrology measurement by generating synthetic training data for a plurality of simulated test features having known simulated values of the metrology measurement; extract the one or more correlated principal components from the synthetic training data as dimensionality-reduced synthetic training data; and generating the synthetic training dataset by filtering the dimensionality-reduced synthetic training data to include portions of the dimensionality-reduced synthetic training data that satisfy a second correlation threshold with the reference data; training a machine learning model to generate a value of the metrology measurement with the real training dataset and the synthetic training dataset; and generating metrology measurements for one or more run-time samples from measurement data associated with the one or more run-time samples

In embodiments, the techniques described herein relate to a metrology system, where the metrology measurement includes at least one of an overlay measurement or a critical dimension measurement.

In embodiments, the techniques described herein relate to a metrology system, where the first metrology sub-system includes an optical metrology tool.

In embodiments, the techniques described herein relate to a metrology system, where the first metrology sub-system includes at least one of a spectral ellipsometry tool or a spectral reflectometry tool.

In embodiments, the techniques described herein relate to a metrology system, where the second metrology sub-system includes at least one of a particle-beam metrology tool or an x-ray metrology tool.

In embodiments, the techniques described herein relate to a metrology system, where the second metrology sub-system includes at least one of a transmission electron microscope, a transmission small-angle x-ray scattering tool, a scanning electron microscope, a critical dimension scanning electron microscope, or an atomic force microscope.

In embodiments, the techniques described herein relate to a metrology system, where at least one of the first correlation threshold or the second correlation threshold is a goodness-of-fit threshold.

In embodiments, the techniques described herein relate to a metrology system, where at least one of the first correlation threshold or the second correlation threshold is an R² threshold.

In embodiments, the techniques described herein relate to a metrology system, where the first correlation threshold is equal to the second correlation threshold.

In embodiments, the techniques described herein relate to a metrology system, where the second correlation threshold is greater to the second correlation threshold.

In embodiments, the techniques described herein relate to a metrology method, including generating a real training dataset for a metrology measurement by receiving real training data from test features on one or more training samples from a first metrology sub-system; receiving reference data associated with the metrology measurement for the test features from a second metrology sub-system; performing a dimensionality reduction operation on the real training data; identifying one or more correlated principal components of the real training data that satisfy a first correlation threshold with the reference data; and generating the real training dataset by filtering the real training data to include portions of the real training data associated with the one or more correlated principal components; generating a synthetic training dataset for the metrology measurement by generating synthetic training data for a plurality of simulated test features having known simulated values of the metrology measurement; extract the one or more correlated principal components from the synthetic training data as dimensionality-reduced synthetic training data; and generating the synthetic training dataset by filtering the dimensionality-reduced synthetic training data to include portions of the dimensionality-reduced synthetic training data that satisfy a second correlation threshold with the reference data; training a machine learning model to generate a value of the metrology measurement with the real training dataset and the synthetic training dataset; and generating metrology measurements for one or more run-time samples from measurement data associated with the one or more run-time samples.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a block diagram of a metrology system in accordance with one or more embodiments of the present disclosure.

FIG. 1B illustrates a simplified schematic of an optical measurement sub-system, in accordance with one or more embodiments of the present disclosure.

FIG. 1C illustrates a simplified schematic of an x-ray measurement sub-system, in accordance with one or more embodiments of the present disclosure.

FIG. 1D illustrates a simplified schematic of a particle beam measurement sub-system 102, in accordance with one or more embodiments of the present disclosure.

FIG. 2A illustrates a flow diagram illustrating steps performed in a metrology method, in accordance with one or more embodiments of the present disclosure.

FIG. 2B illustrates a flow diagram depicting sub-steps associated with the step of generating a real training dataset for a metrology measurement, in accordance with one or more embodiments of the present disclosure.

FIG. 2C illustrates a flow diagram depicting sub-steps associated with the step 216 of generating a synthetic training dataset for the metrology measurement, in accordance with one or more embodiments of the present disclosure.

FIG. 3 illustrates a plot of a correlated principal component of real training data for test features generated using a spectral ellipsometry in-line measurement sub-system plotted as a function of reference data, in accordance with one or more embodiments of the present disclosure.

FIG. 4 illustrates a plot of a correlated principal component associated with both real training data and synthetic training data, in accordance with one or more embodiments of the present disclosure.

FIG. 5 illustrates a plot of real training data and filtered synthetic training data, in accordance with one or more embodiments of the present disclosure.

FIG. 6A illustrates a plot of a correlated principal component associated with a different series of test features, in accordance with one or more embodiments of the present disclosure.

FIG. 6B illustrates a plot of real training data and filtered synthetic training data from FIG. 6A, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing spectral metrology measurements that incorporate machine learning models trained on a combination of real training data and synthetic training data, where the synthetic training data is generated in a manner that preserves a correlation to reference training data.

Spectral metrology is a powerful metrology technique based on illumination of a sample with broadband light and capturing a spectrum of reflected light. In a general sense, the reflected spectrum may be highly sensitive to physical or optical structures on a sample. Further, by controlling properties of the incident illumination and/or the collected light such as, but not limited to, polarization, phase, or angle, different properties of a sample may be measured. Various spectral metrology techniques are within the spirit and scope of the present disclosure including, but not limited to, spectral ellipsometry, reflectometry, scatterometry, or Raman metrology. For example, spectral metrology may be used to generate measurements of some or all Mueller matrix elements that represent an optical response of a sample to the incident illumination. As another example, spectral metrology may be used to generate specific metrology measurements that may be useful for semiconductor process control such as, but not limited to, critical dimension (CD) measurements, pattern asymmetry measurements, tilt measurements, or overlay measurements.

In some embodiments, a machine learning model is developed to generate one or more metrology measurements based on spectral ellipsometry data generated with one or more configurations of illumination and/or collected light. Such a model may be trained with a combination of a real training dataset and a synthetic training dataset.

The real training dataset may be generated based on spectral ellipsometry measurements of fabricated samples having varied physical parameters relevant to the one or more metrology measurements (e.g., different values of CD, pattern asymmetry, tilt, overlay, or the like). Such a process is often referred to as a design of experiments (DOE). Reference data including accurate values of the varied physical parameters (e.g., the one or more metrology measurements of interest) are then generated using a high-resolution reference tool such as, but not limited to, a scanning electron microscope (SEM), a transmission electron microscope (TEM), an atomic force microscope (ATM), a small-angle x-ray scattering (SAXS), or any variants (e.g., CD-SAXS, or the like). In this way, the machine learning model may be trained to generate the one or more metrology measurements based on input spectral ellipsometry data.

The synthetic training dataset may be generated in a manner that ensures correlation to the real training data. In some embodiments, candidate synthetic training data is first generated using a simulation model (e.g., a physical model) that simulates optical interaction with simulated samples that also have varied physical parameters (e.g., a simulated DOE). This candidate synthetic training data is then filtered to only include data that meets a correlation threshold to reference data. As an illustration, a dimensionality reduction technique such as, but not limited to, principal component analysis (PCA) may first be applied to the real training data to determine one or more principal components (PCs) that have a high correlation to the reference data (e.g., correlation above a selected real-data correlation threshold) for a particular sample design. For example, one or more PCs may be linearly correlated with the reference data and have an R² value lower than a real-data correlation threshold.

The same dimensionality reduction analysis may then be applied to the synthetic data such that the PCs identified as being highly correlated to the reference data may be extracted for the synthetic data as well. Finally, the candidate synthetic reference data may be filtered to only include data that meets a selected synthetic-data correlation threshold for one or more PCs or combinations thereof. As an illustration, a plot of the PC of the synthetic data with respect to the reference data may reveal that some of the candidate synthetic data is not well correlated to the reference data, which may be due to a variety of reasons including, but not limited to, unrealistic sample geometries. However, the candidate synthetic data may be filtered to only keep data that maintains the same correlation to the reference data as the real training data. For example, only portions of the candidate synthetic data that maintains an R² value below a synthetic-data correlation threshold are maintained in the synthetic training dataset, where the synthetic-data correlation may the same or different than the real-data correlation threshold.

It is contemplated herein that the systems and methods disclosed herein may provide numerous benefits over existing synthetic data generation techniques. For example, some synthetic training data generation techniques simply use candidate synthetic training data associated with a broad DOE without regard to whether the geometries are realistic and/or without regard for overlap with real training data. However, this technique may suffer from large amounts of unrealistic or counterproductive training data, which may diminish the robustness of the machine learning model. As another example, some synthetic training data generation techniques attempt to filter synthetic training data by comparing different PCs associated with a dimensionality reduction technique, selecting portions of synthetic training data that overlaps with real training data, and generating additional synthetic training data with similar parameter configurations. However, this technique may be time intensive and in practice does not lead to significantly better results. In some cases, this techniques produces inferior results compared to indiscriminately using synthetic training data from a broad DOE. Further, it is contemplated herein that a PC to PC comparison may not be a useful metric for evaluating synthetic training data. Instead, systems and methods disclosed herein provide synthetic training data that correlates to reference data.

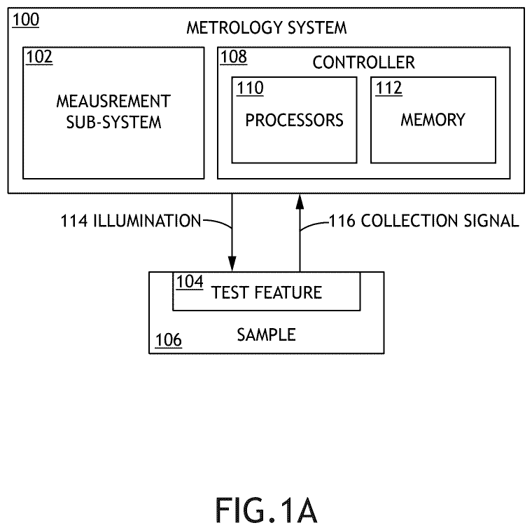

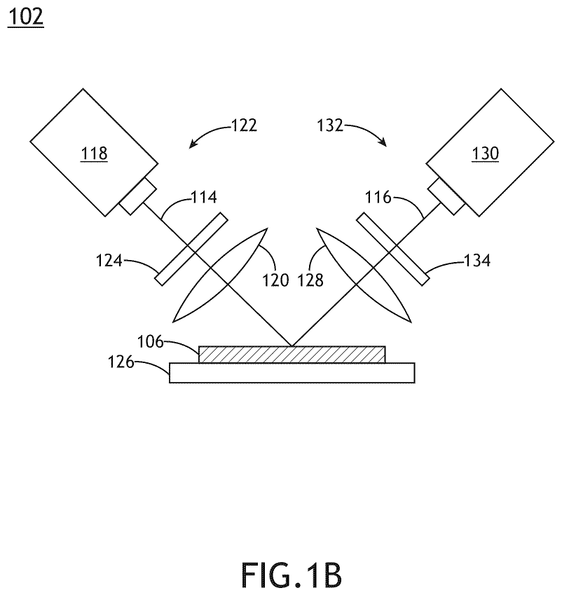

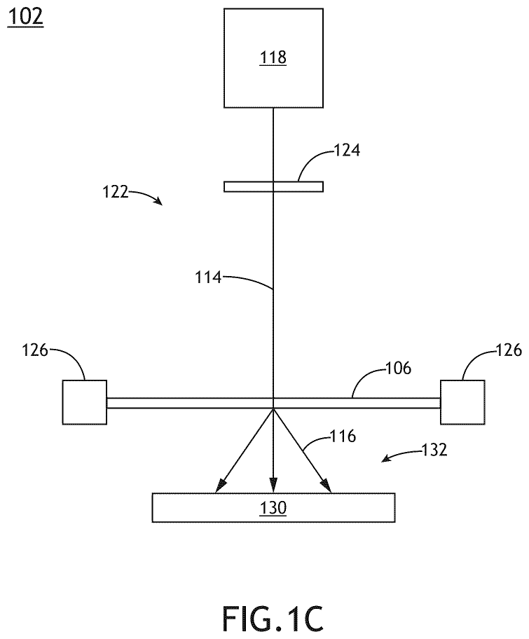

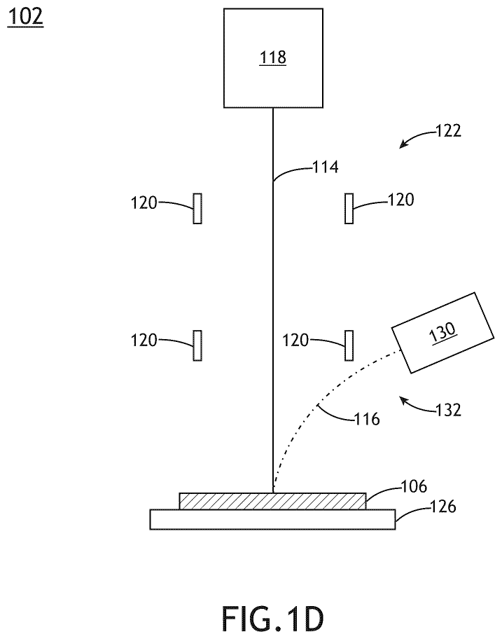

Referring now to FIGS. 1A-6B, systems and methods providing spectral ellipsometry with accurate synthetic training data are described, in accordance with one or more embodiments of the present disclosure.

FIG. 1A illustrates a block diagram of a metrology system 100 in accordance with one or more embodiments of the present disclosure.

In some embodiments, the metrology system 100 includes at least one measurement sub-system 102 to generate measurement data associated with a test feature 104 on a sample 106 and further includes a controller 108 to generate one or more metrology measurements associated with the based on the measurement data. The controller 108 may include one or more processors 110 configured to execute a set of program instructions maintained in a memory 112, or memory device, where the program instructions may cause the processors 110 to implement various actions or steps disclosed herein.

A measurement sub-system 102 may include any components or combination of components suitable for generating measurement data associated with a test feature 104. For example, a measurement sub-system 102 may direct illumination 114 to the test feature 104, capture a collection signal 116 from the test feature 104 in response to the illumination 114, and generate measurement data based on this collection signal 116 (e.g., with a detector), where the measurement data includes information indicative of one or more metrology measurements of interest.

In some embodiments, a measurement sub-system 102 includes an optical measurement sub-system 102 to generate measurement data based on interaction of the sample 106 with illumination 114 including light of any suitable wavelength or combination of wavelengths including, but not limited to, ultraviolet (UV) wavelengths, visible wavelengths, or infrared (IR) wavelengths. For example, an optical measurement sub-system 102 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), a Raman metrology tool, a laser driven spectroscopic reflectometry (LDSR) system, or any combination thereof.

In some embodiments, a measurement sub-system 102 includes an x-ray measurement sub-system 102 to generate measurement data based on interaction of the sample 106 with illumination 114 including x-rays. For example, the measurement sub-systems 102 may include, but is not limited to, a small-angle x-ray scatterometer (SAXR), or a soft x-ray reflectometer (SXR), or an x-ray photoelectron spectroscopy (XPS) system.

In some embodiments, a measurement sub-system 102 includes a particle-beam measurement sub-system 102 to generate measurement data based on interaction of the sample 106 with illumination 114 including a particle beam such as, but not limited to, an electron beam (e-beam), an ion beam, or a neutral particle beam. As an illustration, an e-beam measurement sub-system may include a scanning electron microscope (SEM), a critical dimension SEM (CD-SEM), a grey SEM (e.g., a model-based SEM similar to CD-SEM providing additional information about a measured structure such as, but not limited to, depth, height, bottom CD, or the like), or a transmission electron microscope (TEM).

In some embodiments, the metrology system 100 includes at least two different types of measurement sub-systems 102 having different operational principles and/or different resolutions. For example, the metrology system 100 may include at least one measurement sub-system 102 configured for in-line operation (e.g., an in-line measurement sub-system 102) and at least one measurement sub-system 102 configured for reference operation (e.g., a reference measurement sub-system 102). In this configuration, the metrology system 100 may implement a trained machine learning model to generate one or more metrology measurements based on measurement data from an in-line measurement sub-system 102, where the reference measurement sub-system 102 is used to generate ground truth reference data used to train the machine learning model.

In some applications, a reference measurement sub-system 102 may have a relatively higher accuracy than an in-line measurement sub-system 102, but perhaps a reduced throughput. As an illustration, an in-line measurement sub-system 102 may include an optical measurement sub-system 102 configured to capture at least some Mueller matrix elements associated with a test feature 104, while a reference measurement sub-system 102 may include an x-ray or particle-beam measurement sub-system 102. As another example, an in-line measurement sub-system 102 may include a particle-beam measurement sub-system 102 (e.g., a CD-SEM, a grey SEM, or the like), while a reference measurement sub-system 102 may include a TEM or an XPS system. It is to be understood that these examples are provided solely for illustrative purposes and should not be interpreted as limiting the present disclosure. Rather, the metrology system 100 may include an in-line measurement sub-system 102 of any type and a reference measurement sub-system 102 of any type.

Multiple measurement sub-systems 102 may be provided as a single tool or multiple tools. A single tool providing multiple measurement configurations is generally described in U.S. Pat. No. 7,933,026 issued on Apr. 26, 2011, which is incorporated herein by reference in its entirety. Multiple tool and structure analysis is generally described in U.S. Pat. No. 7,478,019 issued on Jan. 13, 2009, which is incorporated herein by reference in its entirety.

Regardless of the configuration of a measurement sub-system 102, any type of collection signal 116 emanating from the test feature 104 in response to the illumination 114 may be captured to generate the measurement data such as, but not limited to, light, x-rays, or particles.

Further, the measurement sub-system 102 may be configurable to generate metrology measurements based on any number of metrology recipes, where a metrology recipe may define various imaging parameters used to generate measurement data and/or processing techniques to generate metrology measurements from measurement data. For example, a metrology recipe of may include parameters associated with the illumination 114 such as, but not limited to, a number of beams, incidence angles (e.g., azimuth and/or polar incidence angles), polarization, phase characteristics, or wavelength. As another example, a metrology recipe may include parameters associated with the collection signal 116 used to generate the measurement data such as, but not limited to, collection angles (e.g., to collect zero-order double diffraction), polarization, phase characteristics, or wavelength. As another example, a metrology recipe may include sampling characteristics such as, but not limited to, locations on a sample 106 to be measured (e.g., locations of dedicated overlay targets or device features to be characterized) or focus characteristics.

The metrology system 100 may be suitable for generating any type of metrology measurement on any type of test feature 104. Further, the metrology system 100 may generate multiple metrology measurements associated with various sub-features (e.g., critical parameters) associated with a test feature 104 and/or metrology measurements associated with multiple test features 104.

The test feature 104 may be associated with any stage in a fabrication process such as, but not limited to, an etch process, a lithography process, or a deposition process. Non-limiting examples of a test feature 104 includes, but are not limited to, a patterned multi-layer structure, a patterned single-layer structure (e.g., a grating structure, or the like), a film stack (e.g., an unpatterned film stack), or a combination thereof. Further, non-limiting examples of a metrology measurements include, but are not limited to, a CD measurement, a height measurement (e.g., a height of a patterned feature, a height of a multi-layer feature, or the like), an overlay measurement, a tilt measurement, an electrical test measurement (e.g., Vt, work-function, mobility, lon/loff, or the like), a stress or strain measurement, a film thickness, or a material property measurement (e.g., a refractive index measurement, a spectroscopic measurement, or the like).

In some embodiments, the metrology system 100 generates one or more metrology measurements using a machine learning model based on measurement data provided by a measurement sub-system 102. For example, the machine learning model may be embodied in the memory 112 (e.g., as a series of internal weights, or the like) such that the processors 110 of the controller 108 may execute program instructions causing the processors 110 to implement various actions disclosed herein such as, but not limited to, training the machine learning model, receive measurement data (e.g., training data, data for an in-line measurement, or any type of data) from a measurement sub-system 102, generate metrology measurements using a machine learning model, generate correctables based on the metrology measurements, or the like.

The machine learning model may accept measurement data (e.g., raw data) associated with a particular measurement configuration of the measurement sub-system 102. As an illustration, a spectrometry-based optical measurement sub-system 102 may generate signals associated with 15 Mueller matrix elements, with approximately 670 wavelength pixels per signal to provide approximately 10,000 individual signals for a particular measurement configuration. This is merely illustrative, however, and should not be interpreted as limiting the scope of the present disclosure. For example, such a system may generate signals associated with any number of Mueller matrix elements (e.g., up to 16 Mueller matrix elements) and provide any number of datapoints for any number of wavelengths.

As another example, the machine learning model may be trained to accept data derived from one or more sets of measurement data as inputs and may generate one or more metrology measurements as outputs. For instance, the machine learning model may accept dimensionality-reduced measurement data (e.g., one or more PCs) as inputs and may generate one or more metrology measurements as outputs. The dimensionality-reduced measurement data may be generated using any suitable technique including, but not limited to, a principal component analysis (PCA) (e.g., linear or non-linear) or a fast Fourier Transform (FFT) analysis. In a general sense, the principal component set may correspond to aspects of the associated measurement data that are correlated with the metrology measurements of interest.

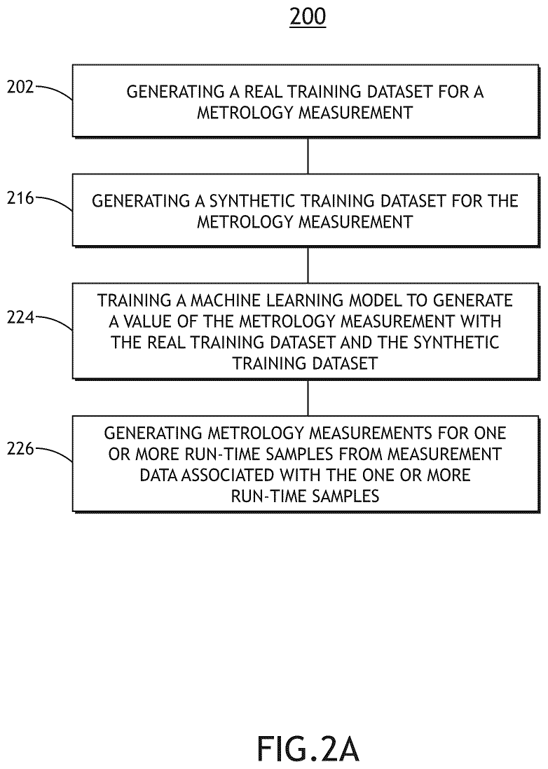

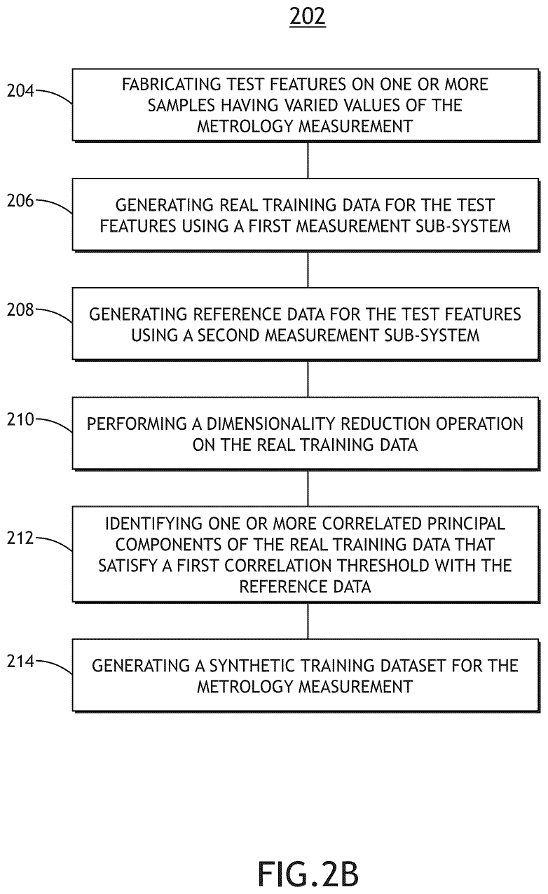

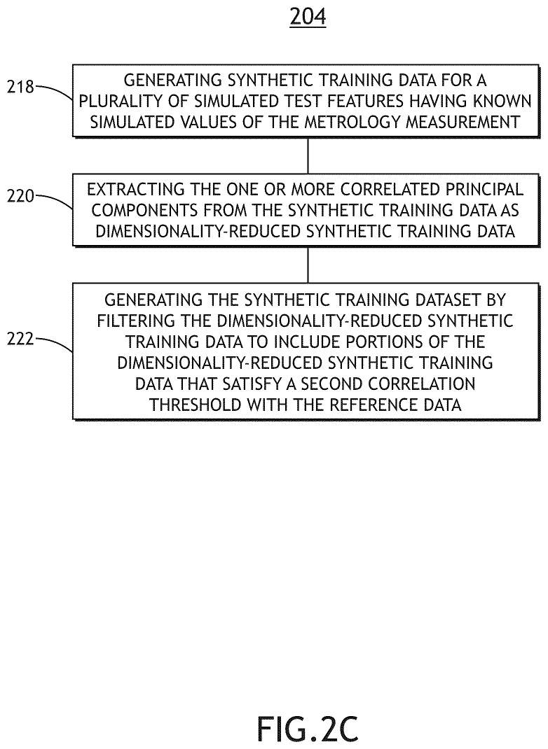

Referring now to FIGS. 2A-6B, the generation of training data for a machine learning model used to generate metrology measurements is described, in accordance with one or more embodiments of the present disclosure.

The machine learning model may incorporate any type or combination of machine learning techniques such as, but not limited to, supervised machine learning techniques, semi-supervised machine learning techniques, reinforcement machine learning techniques, or unsupervised machine learning techniques. As an illustration, a machine learning model may include, is not limited to, a linear model, a neural network model, a polynomial model, a decision tree model, or a random forest model. Further, the machine learning model may be trained using training data, which may be derived from any source.

In some embodiments, the machine learning model is trained on a combination of real training data associated with fabricated samples and synthetically-generated training data (e.g., simulated training data). It is contemplated herein that real training data may beneficially include physical configurations of the test feature 104 that may realistically occur as a result of process variations during a typical fabrication process. However, it may be difficult and/or impractical to generate sufficient real training data to provide robust operation of a machine learning model. It is further contemplated herein that synthetic training data may be relatively easier to generate in the quantities useful for training purposes, but may sometimes correspond to unrealistic physical configurations of the test feature 104 and may thus have limited utility.

For example, one technique for generating synthetic training data is generate synthetic measurement data associated with a wide range of fabrication parameters (e.g., a broad DOE) without regard to the likelihood that various combinations of fabrication parameters may actually occur during a typical fabrication process. This simplistic approach may provide plenty of data, but the presence of potentially large amounts of unrealistic training data may negatively impact the robustness of the machine learning model.

As another example, efforts to filter synthetic training data generated with a broad DOE based on comparisons of principle components of real and synthetic training data may also not provide much benefit and may result in much of the synthetic training data being de-weighted or excluded.

In some embodiments, synthetic training data is generated in a manner that maintains correlation with real reference data, which may enable robust and accurate performance of the machine learning model.

FIG. 2A illustrates a flow diagram illustrating steps performed in a metrology method 200, in accordance with one or more embodiments of the present disclosure. The embodiments and enabling technologies described previously herein in the context of the metrology system 100 should be interpreted to extend to the method 200. For example, the processors 110 of the controller 108 may execute program instructions causing them to implement one or more steps of the method 200 either directly or by generating control signals to direct components internal or external to the metrology system 100 to take actions. However, the method 200 is not limited to the architecture of the metrology system 100.

The method 200 may include a step 202 of generating a real training dataset for a metrology measurement.

FIG. 2B illustrates a flow diagram depicting sub-steps associated with the step 202 of generating a real training dataset for a metrology measurement, in accordance with one or more embodiments of the present disclosure.

The step 202 of generating a real training dataset for a metrology measurement may include a step 204 of fabricating a plurality of test features 104 on one or more samples having varied values of the metrology measurement. For example, the step 204 may include fabricating one or more DOE samples in which multiple fabrication parameters are intentionally varied. In some cases, the fabrication parameters are varied in a way that reflects realistic process variations of process tools used in a high volume manufacturing environment.

The step 202 of generating a real training dataset for a metrology measurement may include a step 206 of generating real training data for the plurality of test features 104 using a first measurement sub-system 102 (e.g., an in-line measurement sub-system 102). For example, the first measurement sub-system 102 may correspond to an optical measurement sub-system 102 such as, but not limited to, a spectral ellipsometry measurement sub-system 102.

The step 202 of generating a real training dataset for a metrology measurement may include a step 208 of generating reference data for the plurality of test features 104 using a second measurement sub-system 102 (e.g., a reference measurement sub-system 102). For example, the second measurement sub-system 102 may correspond to a particle-beam or an x-ray measurement sub-system 102 that may provide a relatively high resolution measurement of the plurality of test features 104. In this way, the reference data may serve as ground truth data for the real training data.

The step 202 of generating a real training dataset for a metrology measurement may include a step 210 of performing a dimensionality reduction operation on the real training data. Any type of dimensionality reduction operation may be utilized such as, but not limited to, principal component analysis or Fourier Transform analysis. In this way, the real training data may be expressed in terms of various principal components that correspond to selected portions of the real training data.

The step 202 of generating a real training dataset for a metrology measurement may include a step 212 of identifying one or more correlated principal components of the real training data that satisfy a first correlation threshold with the reference data. The step 202 of generating a real training dataset for a metrology measurement may include a step 214 of generating the real training dataset by filtering the real training data to include portions of the real measurement data associated with the one or more correlated principal components.

It is contemplated herein that some principle components may provide relatively higher correlations to the reference data than others. Accordingly, the step 212 may involve identifying one or more principal components that satisfy a first correlation threshold, which are then referred to as correlated principal components. Any correlation threshold or metric may be used such as, but not limited to, an R² value or a goodness-of-fit (GoF) threshold. For example, the step 212 may involve one or more correlated principal components that provide an R² value higher than a selected number.

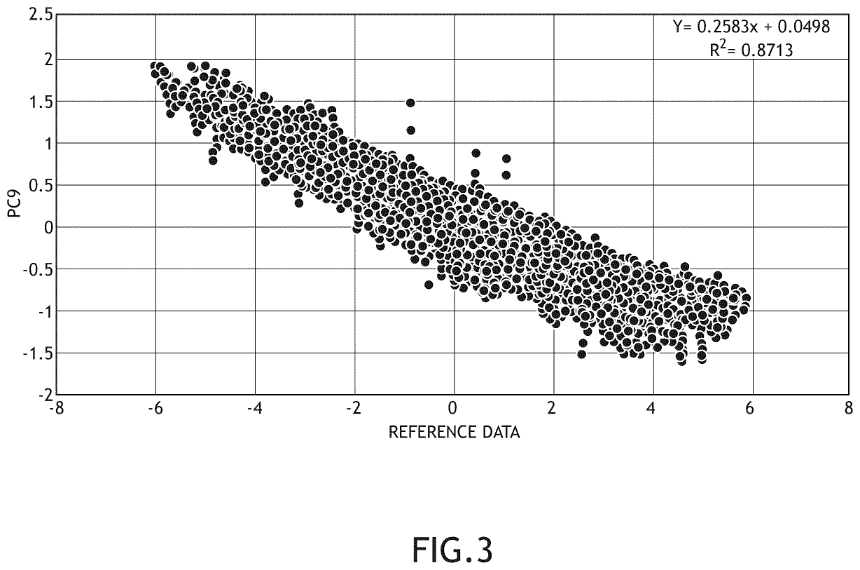

FIG. 3 illustrates a plot of a correlated principal component (PC9) of real training data for DRAM test features 104 generated using a spectral ellipsometry in-line measurement sub-system 102 plotted as a function of reference data generated with a CD-SEM reference measurement sub-system 102, in accordance with one or more embodiments of the present disclosure. The observed R² value for this principal component is ˜0.871.

It is contemplated herein that generating a real training dataset to include correlated principal components providing a strong correlation to reference data (e.g., ground truth data) may be both efficient and provide robust training.

Referring now to FIGS. 2A and 2C, the method 200 may include a step 216 of generating a synthetic training dataset for the metrology measurement. FIG. 2C illustrates a flow diagram depicting sub-steps associated with the step 216 of generating a synthetic training dataset for the metrology measurement, in accordance with one or more embodiments of the present disclosure.

The step 216 of generating a synthetic training dataset for the metrology measurement may include a step 218 of generating synthetic training data for a plurality of simulated test features 104 having known simulated values of the metrology measurement.

The synthetic training data may be generated using any technique. In some embodiments, the synthetic training data is generated using a physics-based measurement model that simulates a measurement of a test feature 104 (e.g., by the first measurement sub-system 102). For example, in a case where the first measurement sub-system 102 is an optical measurement sub-system 102, the measurement model may include an electromagnetic solver based on algorithms such as, but not limited to, rigorous coupled-wave analysis (RCWA) techniques, finite element method (FEM) techniques, method of moments techniques, surface integral techniques, volume integral techniques, finite different time domain (FDTD) techniques, or the like.

The synthetic training data may be generated with a broad DOE. In some cases, the range of fabrication parameters simulated to generate the synthetic training data is larger than the range of fabrication parameters used to generate the real training data.

The step 216 of generating a synthetic training dataset for the metrology measurement may include a step 220 of extracting the one or more correlated principal components from the synthetic training data as dimensionality-reduced synthetic training data.

Continuing the example depicted in FIG. 3, the portions of the synthetic training data associated with the correlated principal components may be extracted from the synthetic training data to provide the dimensionality-reduced synthetic training data.

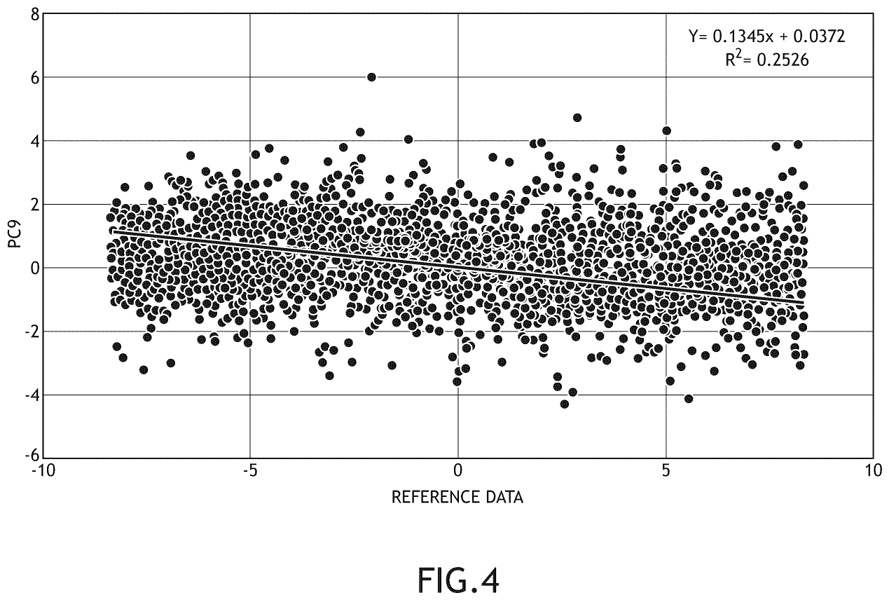

FIG. 4 illustrates a plot of a correlated principal component (PC9) associated with both real training data and synthetic training data (combined), in accordance with one or more embodiments of the present disclosure. In this way, FIG. 4 is an extension of FIG. 3 that further includes data for the same principal component (PC9) from synthetic training data. The observed R² value in FIG. 4 of the combined real training data and synthetic training data is ˜0.253, which indicates that certain portions of the synthetic measurement training data is not in agreement with the real measurement training data. This could be for multiple reasons. For example, certain portions of the synthetic measurement training data may not be accurate and may not represent the corresponding correlation to the reference data. As another example, certain portions of the synthetic measurement training data may cover unrealistic combinations of fabrication parameters and thus have little bearing on expected real measurements.

The step 216 of generating a synthetic training dataset for the metrology measurement may include a step 222 of generating the synthetic training dataset by filtering the dimensionality-reduced synthetic training data to include portions of the dimensionality-reduced synthetic training data that satisfy a second correlation threshold with the reference data. This second correlation threshold may be the same (e.g., equal to) or different than the first correlation threshold.

To continue the example of FIGS. 3-4, the step 222 may include filtering the synthetic measurement training data to only keep portions that maintain a selected R² correlation value (e.g., the second correlation threshold) with the reference data. In this way, only the portions of the synthetic measurement training data that are correlated to the reference data are maintained as part of the synthetic training dataset.

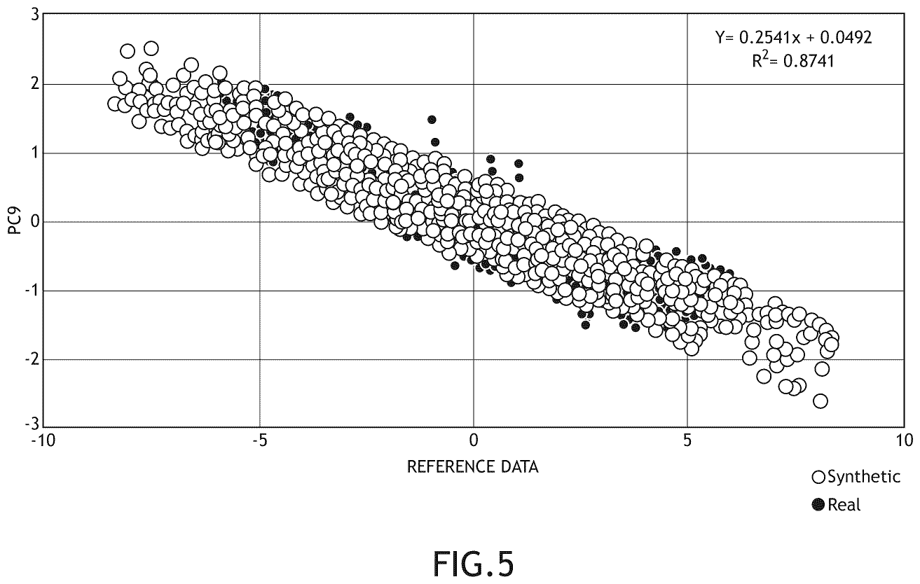

FIG. 5 illustrates a plot of real training data and filtered synthetic training data, in accordance with one or more embodiments of the present disclosure. FIG. 5 corresponds to FIG. 4, where portions of the synthetic training data are filtered out to maintain an R² value (e.g., a second correlation threshold) of 0.87.

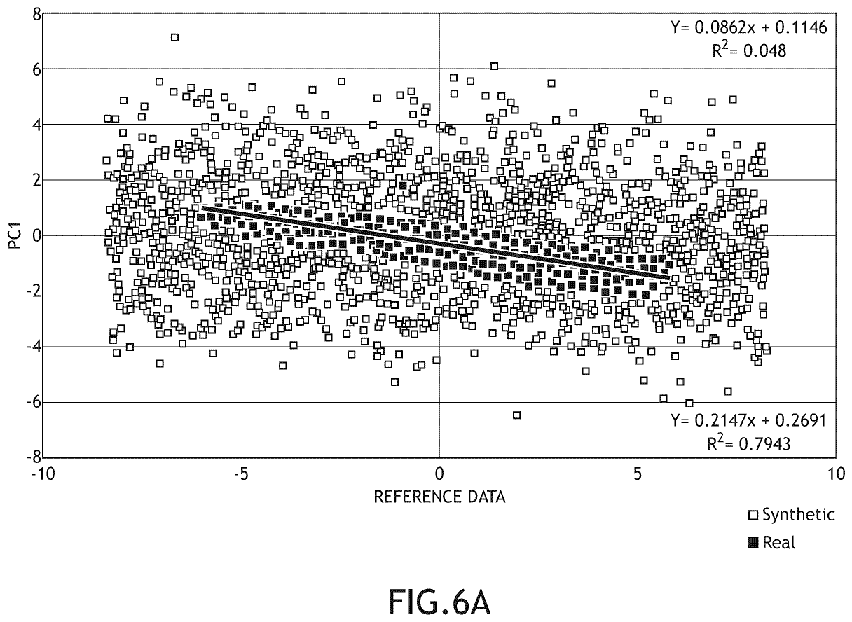

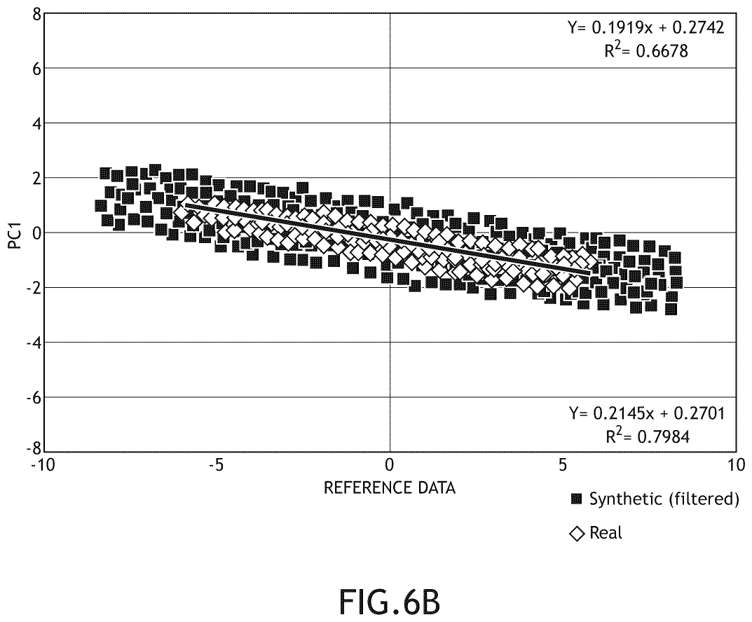

As described previously herein, it is not necessary that the second correlation threshold match the first correlation threshold as shown in FIGS. 4-5. FIG. 6A illustrates a plot of a correlated principal component associated with a different series of DRAM test features 104, in accordance with one or more embodiments of the present disclosure. For example, FIG. 6A may include dimensionality-reduced synthetic training data generated in step 220. In FIG. 6A, the real training data is linearly correlated with reference data with an R² value of 0.794, whereas synthetic training data associated with the same correlated principal component has an R² value of 0.048 indicating poor correlation.

FIG. 6B illustrates a plot of real training data and filtered synthetic training data from FIG. 6A, in accordance with one or more embodiments of the present disclosure. For example, FIG. 6A may include the synthetic training dataset generated by filtering the dimensionality-reduced synthetic training data from FIG. 6A to maintain an R² value of at least 0.66 (the second correlation threshold). As seen in FIG. 6B, making the second correlation threshold less stringent than the first correlation threshold may allow for more synthetic training data within the synthetic training dataset while still ensuring correlation with the reference data. As a result, the trained machine learning model may be accurate and robust.

It is to be understood that although FIGS. 3-6B and the associated descriptions focused on a single correlated principal component, this is merely an illustration and should not be interpreted as limiting the scope of the present disclosure. In some embodiments, the real training dataset and/or the synthetic training dataset includes data associated with multiple correlated principal components.

In some embodiments, the real training dataset and/or the synthetic training dataset are generated based on a mathematical combination (e.g., linear combination, nonlinear combination, or the like) of two or more principal components.

For example, it may be the case that no single principal component associated with the real training data (e.g., from step 210) satisfies a desired correlation threshold (e.g., a first correlation threshold) to the reference data. However, it may be the case that a combination of principal components may satisfy a desired correlation threshold to the reference data. As an illustration, a weighted linear combination of principal components (aPC1+bPC2+ . . . ) may satisfy a desired correlation threshold to the reference data. Any technique may be used to identify a combination of principal components that satisfy a desired correlation threshold including, but not limited to, a LINEST technique.

Accordingly, the step 212 may involve identifying a combination of principal components satisfy a desired correlation threshold to the reference data. Similarly, the step 220 may involve generating dimensionality-reduced synthetic training data associated with the same combination of principal components identified in step 212 and the step 222 may involve filtering the dimensionality-reduced synthetic training data to maintain a second correlation threshold between the dimensionality-reduced synthetic training data and the reference data.

Referring again to FIG. 2A, the method 200 may include a step 224 of training a machine learning model to generate a value of the metrology measurement with the real training dataset and the synthetic training dataset. The method 200 may further include a step 226 of generating metrology measurements for one or more run-time samples from measurement data associated with the one or more run-time samples.

The metrology measurement may correspond to any measurement that may be obtained through analysis of measurement data from the first measurement sub-system 102 including, but not limited to, measurements of one or more Mueller matrix elements, a CD measurement, an overlay measurement, a tilt measurement, or an asymmetry measurement.

The metrology measurement may then be used for any purpose. In some embodiments, the method 200 includes a step of generating correctables for one or more process tools based on the metrology measurement such as, but not limited to, a lithography tool, an etching tool, a polishing tool, or the like. The correctables may be used for any type of control technique. For example, feedback correctables generated based on metrology measurements for test features 104 on one test sample may be used to correct for deviations of process tools fabricating similar test features 104 on subsequent test samples in the same or different lots. As another example, feed-forward correctables generated based on metrology measurements for test features 104 on one test sample may be used to control process tools fabricating additional test features 104 on different sample layers of the same or different test samples.

Referring now to FIGS. 1A-1D, additional aspects of the metrology system 100 are described in greater detail, in accordance with one or more embodiments of the present disclosure.

The one or more processors 110 of a controller 108 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 110 may include any device configured to execute algorithms and/or instructions (e.g., program instructions stored in memory). In some embodiments, the one or more processors 110 may be embodied as a desktop computer, mainframe computer system, workstation, image computer, parallel processor, networked computer, or any other computer system configured to execute a program configured to operate or operate in conjunction with the measurement sub-systems 102, as described throughout the present disclosure. Moreover, different subsystems of the metrology system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 108 may include one or more controllers housed in a common housing or within multiple housings. In this way, any controller or combination of controllers may be separately packaged as a module suitable for integration into metrology system 100.

The memory 112 may include any storage medium known in the art suitable for storing program instructions executable by the associated one or more processors 110. For example, the memory 112 may include a non-transitory memory medium. By way of another example, the memory 112 may include, but is not limited to, a read-only memory (ROM), a random-access memory (RAM), a magnetic or optical memory device (e.g., disk), a magnetic tape, a solid-state drive and the like. It is further noted that the memory 112 may be housed in a common controller housing with the one or more processors 110. In some embodiments, the memory 112 may be located remotely with respect to the physical location of the one or more processors 110 and the controller 108. For instance, the one or more processors 110 of the controller 108 may access a remote memory (e.g., server), accessible through a network (e.g., internet, intranet and the like).

FIGS. 1B-1D depict variations of measurement sub-systems 102, in accordance with one or more embodiments of the present disclosure.

FIG. 1B illustrates a simplified schematic of an optical measurement sub-system 102, in accordance with one or more embodiments of the present disclosure. For example, the measurement sub-systems 102 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), or any combination thereof.

In some embodiments, the measurement sub-systems 102 includes an illumination source 118 configured to generate illumination 114 in the form of at least one illumination beam. The illumination 114 from the illumination source 118 may include one or more selected wavelengths of light including, but not limited to, ultraviolet (UV) radiation, visible radiation, or infrared (IR) radiation. Further, the spatial profile of the illumination 114 on the sample 106 may be controlled by a field-plane stop to have any selected spatial profile.

The illumination source 118 may include any type of illumination source suitable for providing illumination 114 formed from light. In some embodiments, the illumination source 118 is a laser source. For example, the illumination source 118 may include, but is not limited to, one or more narrowband laser sources, a broadband laser source, a supercontinuum laser source, a white light laser source, or the like. In some embodiments, the illumination source 118 includes a laser-sustained plasma (LSP) source. For example, the illumination source 118 may include, but is not limited to, a LSP lamp, a LSP bulb, or a LSP chamber suitable for containing one or more elements that, when excited by a laser source into a plasma state, may emit broadband illumination. In some embodiments, the illumination source 118 includes a lamp source. In some embodiments, the illumination source 118 may include, but is not limited to, an arc lamp, a discharge lamp, an electrode-less lamp, or the like.

The illumination source 118 may provide the illumination 114 using free-space techniques and/or optical fibers.

In some embodiments, the measurement sub-systems 102 directs the illumination 114 to the sample 106 through at least one illumination lens 120 (e.g., an objective lens) via an illumination pathway 122. The illumination pathway 122 may include one or more optical components suitable for modifying and/or conditioning the illumination 114 as well as directing the illumination 114 to the sample 106. In some embodiments, the illumination pathway 122 includes one or more illumination-pathway optics 124 to shape or otherwise control the illumination 114. For example, the illumination-pathway optics 124 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-systems 102 may position the sample 106 for a measurement using any suitable technique. In some embodiments, as illustrated in FIG. 1B, the measurement sub-systems 102 includes a sample stage 126 including one or more actuators (e.g., linear actuators, tip/tilt actuators, rotational actuators, or the like) to position the sample 106 with respect to the illumination beam. In some embodiments, though not explicitly shown, the measurement sub-systems 102 includes beam-scanning optics (e.g., galvanometer mirrors, scanning prisms, or the like) to adjust a position and/or scan one or more beams of illumination 114.

In some embodiments, the measurement sub-systems 102 includes at least one collection lens 128 to capture collection signal 116 (e.g., light), and direct this collection signal 116 to one or more detectors 130 through a collection pathway 132. The collection pathway 132 may include one or more optical elements suitable for modifying and/or conditioning the collection signal 116 from the sample 106. In some embodiments, the collection pathway 132 includes one or more collection-pathway optics 134 to shape or otherwise control the collection signal 116. For example, the collection-pathway optics 134 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-systems 102 may generally include any number or type of detectors 130. For example, the measurement sub-systems 102 may include at least one single-pixel detector 130 such as, but not limited to, a photodiode, an avalanche photodiodes, or a single-photon detectors. As another example, the measurement sub-systems 102 may include at least one mutli-pixel detector 130 such as, but not limited to, a charge-coupled device (CCD) or a complementary metal-oxide semiconductor (CMOS) device, a line detector, or a time-delay integration (TDI) detector.

A detector 130 may be located at any selected location within the collection pathway 132. In some embodiments, the measurement sub-systems 102 includes a detector 130 at a field plane (e.g., a plane conjugate to the sample 106) to generate an image of the sample 106. In some embodiments, the measurement sub-systems 102 includes a detector 130 at a pupil plane (e.g., a diffraction plane) to generate a pupil image. In this regard, the pupil image may correspond to an angular distribution of light from the sample 106 detector 130. For instance, diffraction orders associated with diffraction of the illumination 114 from the sample 106 may be imaged or otherwise observed in the pupil plane. In a general sense, a detector 130 may capture any combination of reflected (or transmitted), scattered, or diffracted light from the sample 106.

The illumination pathway 122 and the collection pathway 132 of the measurement sub-systems 102 may be oriented in a wide range of configurations. For example, as illustrated in FIG. 1B, the illumination pathway 122 and the collection pathway 132 may contain non-overlapping optical paths. In some embodiments, though not explicitly shown, the measurement sub-systems 102 may include a beamsplitter oriented such that a common objective lens may simultaneously direct the illumination 114 to the sample 106 and capture collection signal 116.

FIG. 1C illustrates a simplified schematic of an x-ray measurement sub-system 102, in accordance with one or more embodiments of the present disclosure. Such a measurement sub-systems 102 may be configured as, but is not limited to, a SAXR, a SXR, or an XPS system. X-ray characterization systems and associated measurement techniques are generally described in U.S. Pat. No. 7,929,667 issued on Apr. 19, 2011; U.S. Pat. No. 9,885,962 issued on Feb. 6, 2018; U.S. Pat. No. 10,013,518 issued on Jul. 3, 2018; U.S. Pat. No. 10,324,050 issued on Jun. 18, 2019; U.S. Pat. No. 10,352,695 issued on Jul. 16, 2019; U.S. Pat. No. 10,775,323 issued on Sep. 15, 2020; Lemaillet et al., “Intercomparison between optical and x-ray scatterometry measurements of FinFET structures,” Proceedings of SPIE—The International Society for Optical Engineering, April 2013; Kline, et al. “X-ray scattering critical dimensional metrology using a compact x-ray source for next generation semiconductor devices.” Journal of Micro/Nanolithography, MEMS, and MOEMS 16.1 (2017); U.S. Pat. No. 11,333,621 issued on May 17, 2022; and U.S. Patent Application No. 2021/0207956 published on Jul. 8, 2021; all of which are incorporated herein by reference in their entireties.

In some embodiments, the illumination source 118 is an x-ray source configured to generate x-ray illumination 114 having any particle energies (e.g., soft x-rays, hard x-rays, or the like). The measurement sub-systems 102 may then include any combination of components suitable for capturing an associated collection signal 116, which may include, but is not limited to, x-ray emissions, optical emissions, or particle emissions.

For example, the measurement sub-systems 102 may include at least one x-ray illumination lens 120 and/or illumination-pathway optics 124 suitable for collimating or focusing x-ray illumination 114. Although not shown, the measurement sub-system 102 may further include at least one x-ray collection pathway lens and/or collection-pathway optics suitable for collecting, collimating, and/or focusing the collection signal 116 from the sample 106. Further, the measurement sub-systems 102 may include various illumination-pathway optics 124 and/or collection-pathway optics 134 such as, but not limited to, x-ray collimating mirrors, specular x-ray optics such as grazing incidence ellipsoidal mirrors, polycapillary optics such as hollow capillary x-ray waveguides, multilayer optics, or systems, or any combination thereof. In embodiments, the measurement sub-systems 102 includes an x-ray detector 130 such as, but not limited to, an x-ray monochromator (e.g., a crystal monochromator such as a Loxley-Tanner-Bowen monochromator, or the like), x-ray apertures, x-ray beam stops, or diffractive optics (e.g., such as zone plates).

FIG. 1D illustrates a simplified schematic of a particle beam measurement sub-system 102, in accordance with one or more embodiments of the present disclosure. Such a measurement sub-systems 102 may be configured as, but is not limited to, a SEM, a CD-SEM, a grey SEM, or a TEM.

In some embodiments, the illumination source 118 includes a particle source (e.g., an electron beam source, an ion beam source, or the like) such that the illumination 114 includes a particle beam (e.g., an electron beam, a particle beam, or the like). The illumination source 118 may include any particle source known in the art suitable for generating particle illumination 114. For example, the illumination source 118 may include, but is not limited to, an electron gun or an ion gun. In some embodiments, the illumination source 118 is configured to provide a particle beam with a tunable energy. For example, an illumination source 118 including an electron source may, but is not limited to, provide an accelerating voltage in the range of 0.1 kV to 30 kV. As another example, an illumination source 118 including an ion source may, but is not required to, provide an ion beam with an energy in the range of 1 to 50 keV.

In some embodiments, the measurement sub-system 102 includes one or more particle focusing elements. For example, the one or more particle focusing elements may include, but are not limited to, a single particle focusing element or one or more particle focusing elements forming a compound system. In some embodiments, the one or more particle focusing elements include illumination lens 120 configured to direct the particle illumination beam to the sample 106. Further, the one or more particle focusing elements may include any type of electron lenses known in the art including, but not limited to, electrostatic, magnetic, uni-potential, or double-potential lenses.

In some embodiments, the measurement sub-systems 102 includes one or more particle detectors 130 to image or otherwise detect particles emanating from the sample 106. For example, the detector 130 may include an electron collector (e.g., a secondary electron collector, a backscattered electron detector, or the like). As another example, the detector 130 may include a photon detector (e.g., a photodetector, an x-ray detector, a scintillating element coupled to photomultiplier tube (PMT) detector, or the like) for detecting electrons and/or photons from the sample surface.

Referring now generally to FIGS. 1A-6B, the systems and methods disclosed herein may provide numerous advantages and applications, such as, but not limited to, identifying the process space through real measured PCs correlation to real reference, identifying accurate synthetic spectra using the same correlation, and filtering inaccurate synthetic spectra using the relationship between real PCs and real reference. The systems and methods may further provide for selecting a different set of synthetic spectra per critical parameter, training each critical parameter with different synthetic spectra while retaining accurate and process-consistent ones, setting up criteria using measured spectra and real reference to retain or exclude synthetic spectra, developing linear or non-linear relationships between a combination of measured PCs and the measured reference, and setting up criteria specifications to retain synthetic spectra and exclude out-of-specifications synthetic spectra.

The reference-based synthetic DOE generation can be applied to any type of low reference sampling use cases or low sensitivity features to be measured, such as semiconductor process CD and film thickness, and process monitoring for material size (thickness), composition, or other property changes in real time, such as atomic layer growth in semiconductor processes, chemical or biologic reactions resulting in materials quantity or property changes. Targeted semiconductor metrology applications and benefits include, but are not limited to, Etch SCD of logic devices at 2 nm and 14-Angstrom nodes and beyond, GAA Nanosheet and Nanowire device transistor forming FEOL and interconnect MEOL processes with many features as small as a few nanometers or even down to 1 nm. This method is expected to improve robustness 2 to 3 times and enable capable metrology for these advanced node processes, increasing recipe refresh need time from 3 weeks to 3 months, and providing recipes with better robustness, accuracy, precision, and stability.

Additionally, systems and methods disclosed herein may apply to Etch SCD for DRAM devices at 10 nm or below nodes, where many small features and dimensions need to be measured and controlled, but lack enough reference sampling. The method will augment accurate synthetic spectra and references to these small features, enabling recipes and libraries to be developed with better accuracy, stability, and robustness against process changes. For Logic/Foundry GAA devices, the systems and methods disclosed herein may aid in high-k and metal gate process monitoring and control for 2 nm GAA nodes and beyond, where thicknesses are becoming thinner and more composite layers require measurement, including dipole doping layers that are only one to two mono-atomic layers. It also improves the measurement performance and capability of individual layers in Logic/Foundry GAA devices with Si/SiGe superlattice, which have 7-12 or more layers requiring individual layer thickness and composition measurement. This reduces time to solution and increases the blind test pass rate. Lastly, it is expected to reduce recipe development time for DRAM In-Die Overlay (IDO) and enable a more robust recipe quality metric (QM) to track measurement robustness.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A metrology system, comprising:
a controller including one or more processors configured to execute program instructions causing the one or more processors to implement a metrology recipe by:
generating a real training dataset for a metrology measurement by:
receiving real training data from test features on one or more training samples from a first metrology sub-system;
receiving reference data associated with the metrology measurement for the test features from a second metrology sub-system;
performing a dimensionality reduction operation on the real training data;
identifying one or more correlated principal components of the real training data that satisfy a first correlation threshold with the reference data; and
generating the real training dataset by filtering the real training data to include portions of the real training data associated with the one or more correlated principal components;
generating a synthetic training dataset for the metrology measurement by:
generating synthetic training data for a plurality of simulated test features having known simulated values of the metrology measurement;
extract the one or more correlated principal components from the synthetic training data as dimensionality-reduced synthetic training data; and
generating the synthetic training dataset by filtering the dimensionality-reduced synthetic training data to include portions of the dimensionality-reduced synthetic training data that satisfy a second correlation threshold with the reference data;
training a machine learning model to generate a value of the metrology measurement with the real training dataset and the synthetic training dataset; and
generating metrology measurements for one or more run-time samples from measurement data associated with the one or more run-time samples.

2. The metrology system of claim 1, wherein the dimensionality reduction operation comprises a principal component analysis.

3. The metrology system of claim 1, wherein the metrology measurement comprises at least one of an overlay measurement or a critical dimension measurement.

4. The metrology system of claim 1, wherein the first metrology sub-system comprises an optical metrology tool.

5. The metrology system of claim 1, wherein the first metrology sub-system comprises at least one of a spectral ellipsometry tool or a spectral reflectometry tool.

6. The metrology system of claim 1, wherein the second metrology sub-system comprises at least one of a particle-beam metrology tool or an x-ray metrology tool.

7. The metrology system of claim 1, wherein the second metrology sub-system comprises at least one of a transmission electron microscope, a transmission small-angle x-ray scattering tool, a scanning electron microscope, a critical dimension scanning electron microscope, or an atomic force microscope.

8. The metrology system of claim 1, wherein at least one of the first correlation threshold or the second correlation threshold is a goodness-of-fit threshold.

9. The metrology system of claim 1, wherein at least one of the first correlation threshold or the second correlation threshold is an R² threshold.

10. The metrology system of claim 1, wherein the first correlation threshold is equal to the second correlation threshold.

11. The metrology system of claim 1, wherein the second correlation threshold is greater to the second correlation threshold.

12. A metrology system, comprising:
a first metrology sub-system;
a second metrology sub-system; and
a controller including one or more processors configured to execute program instructions causing the one or more processors to implement a metrology recipe by:
generating a real training dataset for a metrology measurement by:
receiving real training data from test features on one or more training samples from the first metrology sub-system;
receiving reference data associated the metrology measurement for the test features from the second metrology sub-system;
performing a dimensionality reduction operation on the real training data;
identifying one or more correlated principal components of the real training data that satisfy a first correlation threshold with the reference data; and
generating the real training dataset by filtering the real training data to include portions of the real training data associated with the one or more correlated principal components;
generating a synthetic training dataset for the metrology measurement by:
generating synthetic training data for a plurality of simulated test features having known simulated values of the metrology measurement;
extract the one or more correlated principal components from the synthetic training data as dimensionality-reduced synthetic training data; and
generating the synthetic training dataset by filtering the dimensionality-reduced synthetic training data to include portions of the dimensionality-reduced synthetic training data that satisfy a second correlation threshold with the reference data; and
training a machine learning model to generate a value of the metrology measurement with the real training dataset and the synthetic training dataset; and
generating metrology measurements for one or more run-time samples from measurement data associated with the one or more run-time samples.

13. The metrology system of claim 12, wherein the metrology measurement comprises at least one of an overlay measurement or a critical dimension measurement.

14. The metrology system of claim 12, wherein the first metrology sub-system comprises an optical metrology tool.

15. The metrology system of claim 12, wherein the first metrology sub-system comprises at least one of a spectral ellipsometry tool or a spectral reflectometry tool.

16. The metrology system of claim 12, wherein the second metrology sub-system comprises at least one of a particle-beam metrology tool or an x-ray metrology tool.

17. The metrology system of claim 12, wherein the second metrology sub-system comprises at least one of a transmission electron microscope, a transmission small-angle x-ray scattering tool, a scanning electron microscope, a critical dimension scanning electron microscope, or an atomic force microscope.

18. The metrology system of claim 12, wherein at least one of the first correlation threshold or the second correlation threshold is a goodness-of-fit threshold.

19. The metrology system of claim 12, wherein at least one of the first correlation threshold or the second correlation threshold is an R² threshold.

20. The metrology system of claim 12, wherein the first correlation threshold is equal to the second correlation threshold.

21. The metrology system of claim 12, wherein the second correlation threshold is greater to the second correlation threshold.

22. A metrology method, comprising:
generating a real training dataset for a metrology measurement by:
receiving real training data from test features on one or more training samples from a first metrology sub-system;
receiving reference data associated with the metrology measurement for the test features from a second metrology sub-system;
performing a dimensionality reduction operation on the real training data;
identifying one or more correlated principal components of the real training data that satisfy a first correlation threshold with the reference data; and
generating the real training dataset by filtering the real training data to include portions of the real training data associated with the one or more correlated principal components;
generating a synthetic training dataset for the metrology measurement by:
generating synthetic training data for a plurality of simulated test features having known simulated values of the metrology measurement;
extract the one or more correlated principal components from the synthetic training data as dimensionality-reduced synthetic training data; and
generating the synthetic training dataset by filtering the dimensionality-reduced synthetic training data to include portions of the dimensionality-reduced synthetic training data that satisfy a second correlation threshold with the reference data;
training a machine learning model to generate a value of the metrology measurement with the real training dataset and the synthetic training dataset; and
generating metrology measurements for one or more run-time samples from measurement data associated with the one or more run-time samples.
